(19) United States
(12) Patent Application Publication
(10) Pub. No.: US 2023/0358546 A1
(43) Pub. Date: Nov. 9, 2023

(54) MAP MATCHING TRAJECTORIES

(71) Applicant: Navenio Ltd., Oxford (GB)

(72) Inventors: Matthew David Broadway; Sean Thomas George Maguire; Muhammad Sarfraz Nawaz; Agathoniki Trigoni

(73) Assignee: Navenio Ltd., Oxford (GB)

(21) Appl. No.: 18/006,069

(22) PCT Filed: Jul. 9, 2021
(86) PCT No.: PCT/GB2021/051761

§ 371 Date: Jan. 19, 2023

(30) Foreign Application Priority Data
Jul. 20, 2020 (GR) 20200100427
Aug. 21, 2020 (GB) 2013048.0

(51) Int. Cl. G01C 21/30; G01C 21/00

(52) U.S. Cl. CPC G01C 21/30; G01C 21/005

(57) ABSTRACT

A computer implemented method (400) of locating a plurality of mobile device trajectories (301) relative to each other and a map (1, 1′), the mobile device trajectories (301) comprising a time series of position nodes (303) joined by edges (305), the method (400) comprising: obtaining an input pose graph (311) comprising a plurality of mobile device trajectories (301) and a plurality of first constraints (309) defining the position and orientation of nodes (303) and edges (305) of the trajectories relative to each other; performing a non-linear optimisation process on the input pose graph (311) based on the first constraints (309), to reduce a cost function associated with the first constraints (309), the non-linear optimisation process providing a modified pose graph (313); extracting one or more sub-graphs from the modified pose graph (313), and for each sub-graph, individually processing the sub-graph to map match the nodes (303) and edges (305) of the sub-graph to features defined in the map (1,1′); and generating second constraints (317) based on the one or more map matched sub-graphs.

The present disclosure relates to a method of locating a plurality of mobile device trajectories relative to each other and a map, and to a related data processing system.

Various techniques are known for determining the trajectory (path) along which a mobile device is moved. The trajectory comprises a time series of nodes corresponding to the sequential position of the device, with edges or vectors extending between the nodes.

In many cases Global Navigation Satellite Systems (GNSSs), such as Global Positioning System (GPS), Global Navigation Satellite System (GLONASS), Galileo or BeiDou Navigation Satellite System (BDS), may be used to determine the position of nodes. However, in many other cases, GNSS positioning is not suitable. For example inside or in close proximity to buildings, GNSS positioning may not be available or may be unreliable.

Where GNSS positioning is unavailable or unreliable, the trajectory may be determined using sensor data from the mobile device, such as inertial and/or visual data, and techniques such as odometry (e.g. pedestrian dead reckoning). In these cases, each node may include a position and orientation that relates the position of the node to previous and/or subsequent nodes. A node including this position and orientation information is referred to as a pose. A dataset of one or more trajectories may be referred to as a pose graph.

Where a data set comprises many trajectories collected by one or more devices, a non-linear optimisation technique, such as one used at the backend of Simultaneous Localization and Mapping (SLAM), can be used to process the trajectories together to estimate pose information for each node. To do so, it uses motion constraints, absolute location constraints and loop closure constraints.

Motion constraints provide information on the relative position of two consecutive nodes in a trajectory, and may be derived from inertial, visual, thermal, radar, wheel odometry or other odometry sensors, or a combination thereof.

Absolute location constraints could be derived from GNSS or from sensing ambient signals, where the ambient signal fingerprints are mapped in a frame of reference defined by a GNSS system, so that the position of a device can be derived from the detected signal fingerprint. Ambient signals may be BTLE, WiFi, RFID or the like. Furthermore, pressure and other sensor data indicative of absolute location may be used.

Loop closure constraints (also referred to re-localisation constraints) indicate that a node of one trajectory is at the same place as (or close to) another node of the same trajectory at a different time, or a node of a different trajectory. Loop closure constraints encode relative pose information between two nodes of the same or different trajectories, and can be derived based on observations of a variety of signals detected at two poses (or in their close vicinity) using one of a variety of similarity metrics between these signals.

A frontend of the optimiser generates the constraints from the available sensor data. The optimiser (e.g. a SLAM backend) then solves for new corrected poses for all trajectory nodes, so that the ensemble of constraints are best satisfied. Each constraint will have an associated error that characterises the deviation of the pose graph from that constraint. The optimiser attempts to minimise a cost function based on the sum of the errors. In the resulting pose graph, the trajectory poses are in the same consistent reference frame as each other, which may be georeferenced or not.

It will be appreciated that in various scenarios such as tracking, mapping footfall, and mapping other characteristics such as WiFi signal or other signals, it can be desirable to align trajectories obtained from mobile devices moving through an area with a map of the area. A map may encode information on the traversable areas, and may cover indoor and outdoor spaces. It may encode floor change structures (elevators, escalators, staircases, etc), structures connecting buildings (e.g. skyways), and other structures to facilitate entry/exit into the building, such as entry stairs and ramps.

However, in situations where there is little or no GNSS data in the pose graph, the pose graph may not be consistent with the physical map. The optimiser output can be inaccurate for several reasons. For example, loop closures may be inaccurate, motion constraints may be noisy, there may be few absolute location constraints or absolute location constraints may contradict each other.

Map matching can be used to align trajectories to maps by aligning similar points on the pose graph and map. Typical techniques include Hidden Markov Models, Particle Filters, and Conditional Random Fields. These techniques can be used to align a single trajectory to a map, but have not been used to exploit loop closure (re-localisation) constraints within or across trajectories.

According to a first aspect of the invention, there is provided a computer implemented method of locating a plurality of mobile device trajectories relative to each other and a map, the mobile device trajectories comprising a time series of position nodes joined by edges, the method comprising:
a. obtaining an input pose graph comprising a plurality of mobile device trajectories and a plurality of first constraints defining the position and orientation of nodes and edges of the trajectories relative to each other;
b. performing a non-linear optimisation process on the input pose graph based on the first constraints, to reduce a cost function associated with the first constraints, the non-linear optimisation process providing a modified pose graph;
c. extracting one or more sub-graphs from the modified pose graph, and for each sub-graph, individually processing the sub-graph to map match the nodes and edges of the sub-graph to features defined in the map;
d. generating second constraints based on the one or more map matched sub-graphs;
e. combining the first constraints and second constraints to form new fused constraints; and
f. repeating the non-linear optimisation process using the new fused constraints, to reduce the cost function, the processing providing a second modified pose graph.

According to a second aspect of the invention, there is provided a computer implemented method of locating a plurality of mobile device trajectories relative to each other and a map, the mobile device trajectories comprising a time series of position nodes joined by edges, the method comprising:
a. obtaining an input pose graph comprising a plurality of mobile device trajectories and a plurality of first constraints defining the position and orientation of nodes and edges of the trajectories relative to each other;
b. performing a non-linear optimisation process on the input pose graph based on the first constraints, to reduce a cost function associated with the first constraints, the non-linear optimisation process providing a modified pose graph;
c. extracting one or more sub-graphs from the modified pose graph, and for each sub-graph, individually processing the sub-graph to map match the nodes and edges of the sub-graph to features defined in the map;
d. generating second constraints based on the one or more map matched sub-graphs;
e. calculating a cost function based on the second constraints;
   if the cost function based on the second constraints is above a threshold iteratively repeating the process; and
   if the cost function based on the second constraints is below the threshold, terminating the method and outputting the one of the input pose graph and the modified pose graph.

Iteratively repeating the process if the cost function based on the second constraints is above a threshold may comprise: combining the first constraints and second constraints to form new fused constraints; and repeating steps b to e, wherein the new fused constraints from step f are used as the first constraints in step b.

Repeating the non-linear optimisation process may comprise applying the new fused constraints to the modified pose graph obtained from the previous performance of the non-linear optimisation process.

Each of the first constraints and second constraints may have an associated uncertainty. The uncertainty may determine the contribution of the constraint to the cost function. Combining the first constraints and second constraints to form new fused constraints may comprise: combining the first constraints and second constraints; and modifying the uncertainty of the first constraints and second constraints.

Calculating a cost function based on the second constraints may comprise: segmenting the modified pose graph into a plurality of regions, each having a separate cost function, the plurality of regions including low cost regions in which the cost function for the second constraints has relatively low mean or variance and high cost regions in which the cost function for the second constraints has relatively higher mean or variance.

The methods may further comprise: selecting sub-graphs representing the high cost regions; iteratively repeating the process of fusing first and second constraints for the selected sub-graphs. The selected sub-graphs may be combined into a single pose graph prior to fusing the constraints.

In a particular iteration, the non-linear optimisation process may be performed on the full pose graph. Extracting one or more sub-graphs from the modified pose graph may comprise extracting the one or more sub-graphs from the high cost regions, in the previous iteration.

The plurality of regions may be overlapping.

The methods may comprise: terminating the method when one of the following criteria are met: a maximum number of iterations is performed; the cost function based on the second constraints increases over a number of iterations, or is unstable over a number of iterations.

At least one of the one or more sub-graphs may comprise one or more of the following:
all the nodes and edges corresponding to a single trajectory or a segment of a single trajectory; and/or
all the nodes and edges corresponding to a selected subset of two or more trajectories or segments thereof, and loop closure constraints connecting pairs of nodes or edges in the selected subset; and/or
nodes from two or more trajectories having a corresponding common feature detected in device sensor data concurrent with the node.

A sub-graph comprising nodes from two or more trajectories having a corresponding common feature may further comprise nodes and edges within a threshold distance of the nodes having a corresponding common feature.

The methods may comprise, between processing the input pose graph based on the first constraints in a non-linear optimisation process and extracting one or more sub-graphs from the modified pose graph: applying a rigid transform to the pose graph to align the pose graph with features of the map, wherein the one or more sub-graphs are extracted from the rigidly transformed pose graph.

The method may comprise generating location constraints based on the rigid transformation, and incorporating the location constraints into the first constraints.

The rigid transformation may align nodes having location information defined in the frame of reference of the map with corresponding locations on the map.

The location information associated with nodes may comprise one or more of: GNSS data; and/or a distance and/or orientation from a wireless beacon or another unique and recognisable landmark on the map, determined based on a signal detected at the device or by a signal detected by another external device communicated to the device.

The first constraints may comprise:
absolute location constraints; and/or
loop closure/relocalisation constraints, identifying relative pose information between two nodes or between two short sequences of nodes in different trajectories, or in the same trajectory but at a different time period, unspecified in the frame of the map; and/or
motion constraints between consecutive nodes in the same trajectory.

The second constraints may comprise:
absolute location constraints; and/or
loop closure/relocalisation constraints, identifying relative pose information between two nodes or between two short sequences of nodes in different trajectories, or in the same trajectory but at a different time period, unspecified in the frame of the map; and/or
motion constraints between consecutive nodes in the same trajectory.

The non-linear optimisation process may be iterative, and may be stopped after a pre-determined number of iterations, without a convergence check.

Obtaining an input pose graph may comprise: obtaining and pre-processing device sensor data and map data pertaining to the same area to form trajectories; and/or pre-processing map data to form an internal representation the map.

Obtaining an input pose graph may further comprise: generating an initial pose graph based on the trajectories.

Individually processing the sub-graph to map match the nodes and edges of the sub-graph to features defined in the map may comprise one or more of:
a probabilistic state estimation algorithm based on directed graphical models;
a probabilistic state estimation algorithm based on undirected graphical models;
an as rigid as possible transformation;
a point registration algorithm;
other graph matching algorithms.

The non-linear optimisation process may comprise a simultaneous localisation and mapping algorithm.

According to a third aspect of the invention, there is provided a data processing system for locating a plurality of mobile device trajectories relative to each other and a map, the mobile device trajectories comprising a time series of position nodes joined by edges, the data processing system comprising: processing circuitry arranged to perform the method of the first or second aspect.

According to a fourth aspect of the invention, there is provided a computer-readable medium containing instructions which, when run on a system including processing circuitry, cause that system to:
(i) perform the method of the first or second aspect; and/or
(ii) implement the data processing system of the third aspect.

Non-linear optimisation does not provide a mechanism to leverage the full range of physical map constraints, and on the other hand, map matching does not provide a mechanism to leverage the full range of constraints used in the non-linear optimiser. Various embodiments of the invention provide a uniform method of leveraging both sensor observations from mobile devices (encoded in motion, location and loop closure constraints) and physical map information, where such is provided.

The skilled person would understand that features described with respect to one aspect of the invention may be applied, mutatis mutandis, to the other aspects of the invention.

The machine readable medium referred to in any of the above aspects of the invention may be any of the following: a CDROM; a DVD ROM/RAM (including −R/−RW or +R/+RW); a hard drive; a memory (including a USB drive; an SD card; a compact flash card or the like); a transmitted signal (including an Internet download, ftp file transfer of the like); a wire; etc.

There now follows by way of example only a detailed description of embodiments of the present invention with reference to the accompanying drawings in which:

Embodiments of the invention will now be described, by way of example only, with reference to the accompanying drawings, in which:

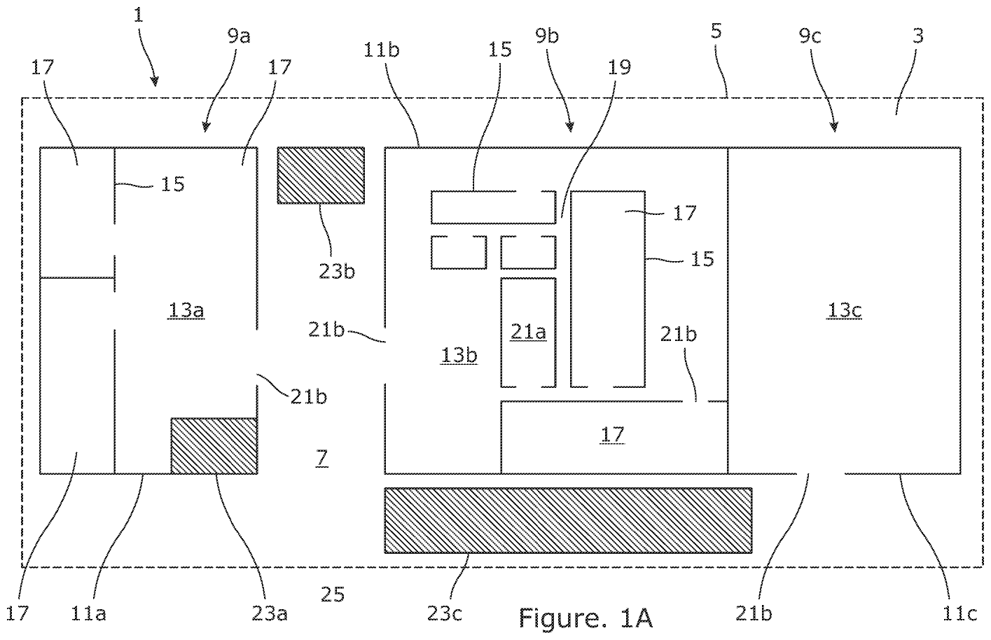

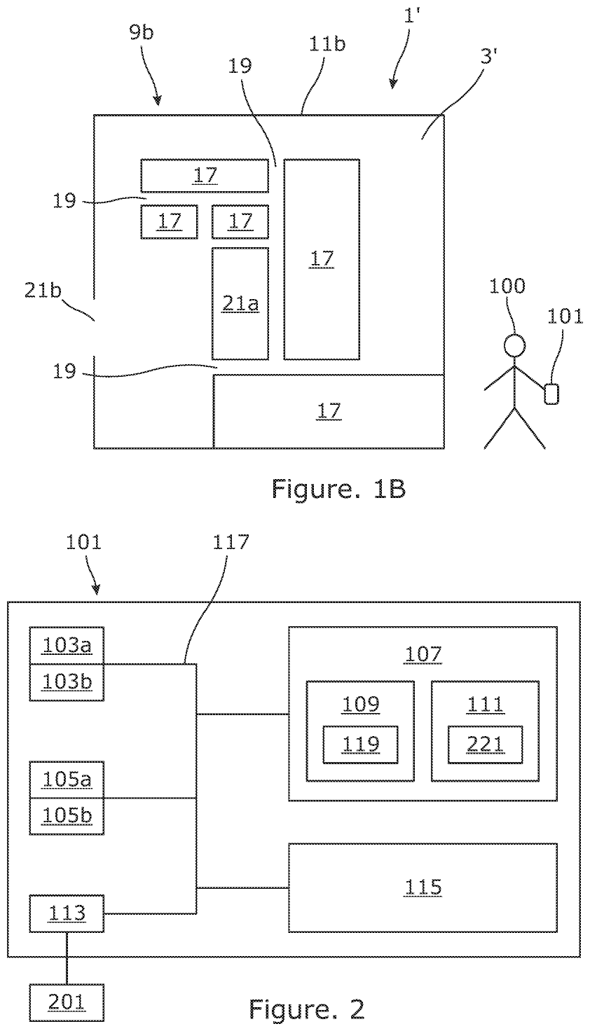

FIG. 1A schematically illustrates an example of a map of an area;

FIG. 1B schematically illustrates a simplified map of one of the buildings shown in the map in FIG. 1;

FIG. 2 schematically illustrates a mobile device according to embodiments of the invention;

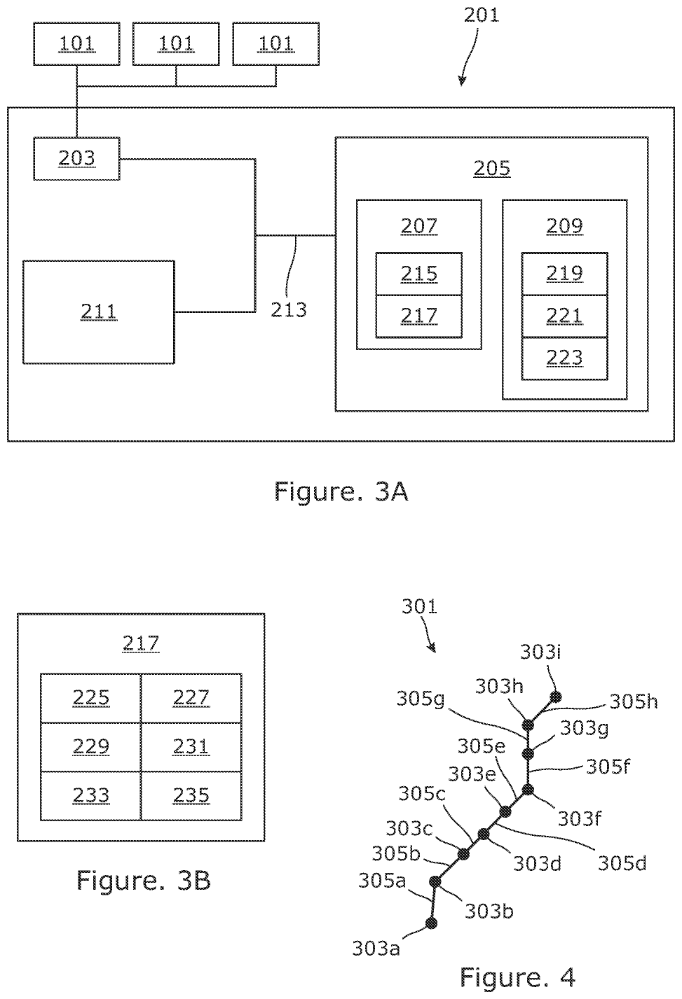

FIG. 3A schematically illustrates a data processing system according to embodiments of the invention;

FIG. 3B shows the trajectory processing module of the data processing system shown in FIG. 3A in more detail;

FIG. 4 illustrates an example of a trajectory of a mobile device moving through an area;

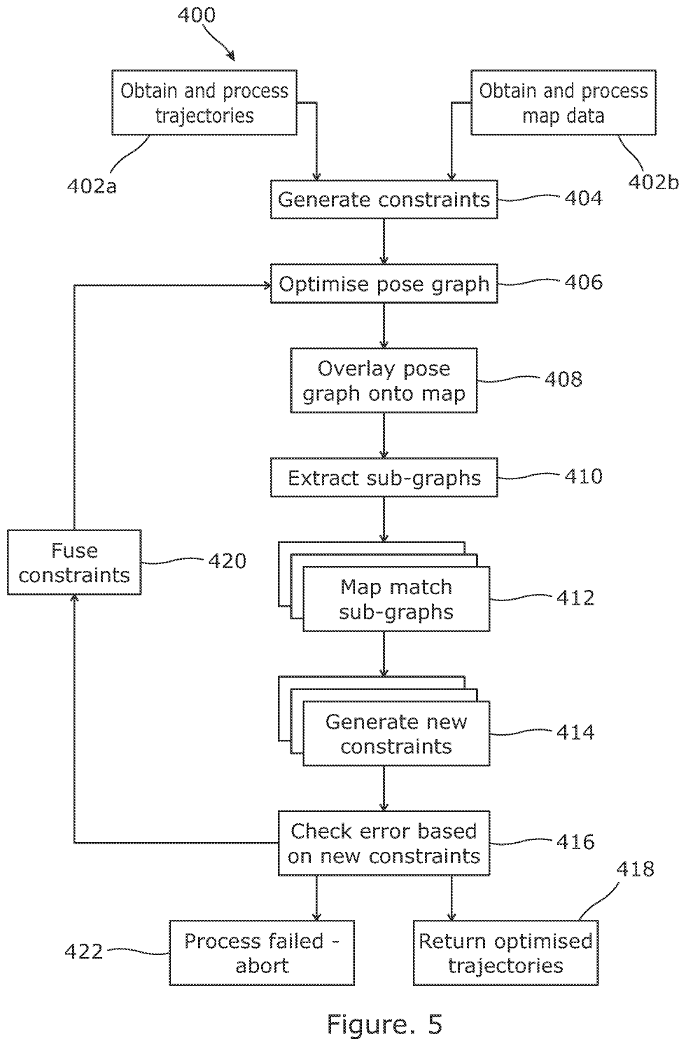

FIG. 5 illustrates a flow chart of a method for locating a plurality of mobile device trajectories relative to each other and a map;

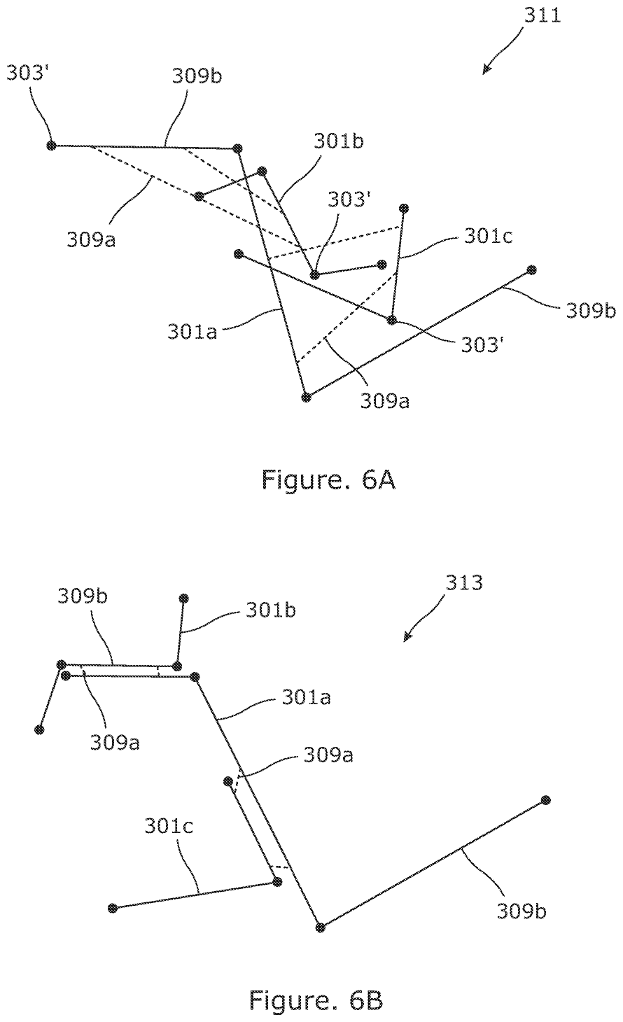

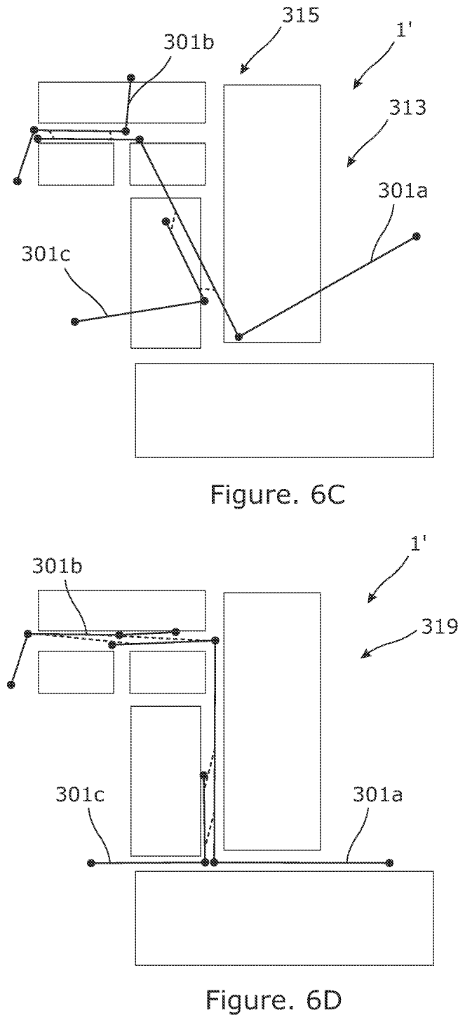

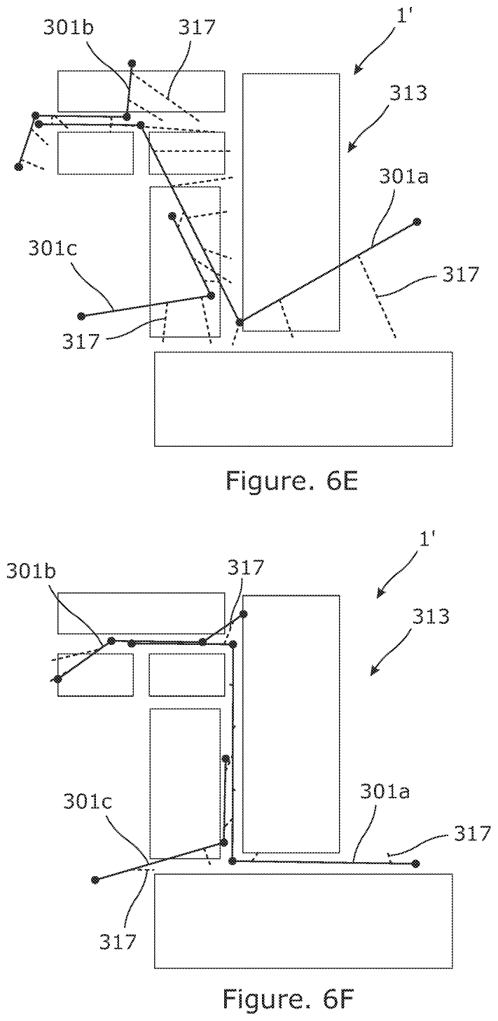

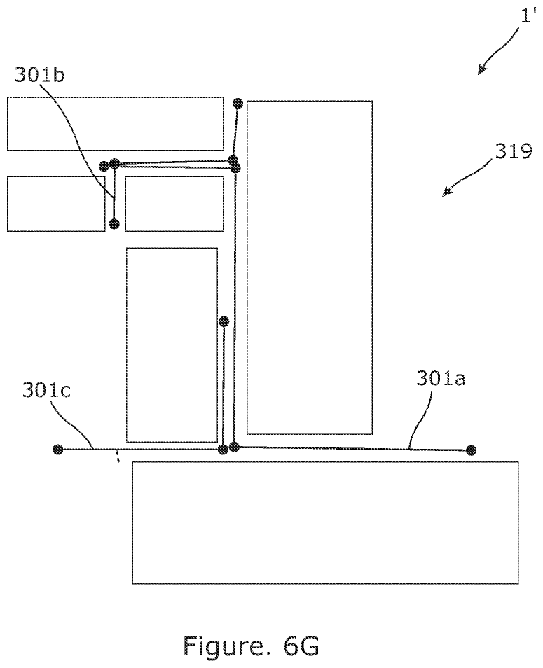

FIG. 6A schematically illustrates a plurality of trajectories taken within the area shown by the map of FIG. 1B, with loop closure constraints and motion constraints illustrated on the trajectories;

FIG. 6B schematically illustrates the pose graph obtained by applying a non-linear optimiser to the trajectories and loop closures shown in FIG. 6A;

FIG. 6C schematically illustrates the pose graph of FIG. 6B, overlaid on the map of FIG. 1B;

FIG. 6D schematically illustrates the result of map matching each of the trajectories in the pose graph of FIGS. 6B and 6C, against the map of FIG. 1B;

FIG. 6E illustrates new constraints derived from the map matching process;

FIG. 6F illustrates the modified pose graph obtained from a second iteration of the non-linear optimisation process, using the original constraints shown in FIG. 6A, and the new constraints from the map matching process shown in FIG. 6E; and

FIG. 6G schematically illustrates the result of map matching each of the trajectories in the pose graph of FIG. 6F, against the map of FIG. 1B.

FIG. 1A schematically illustrates an example of a map 1 showing an area 3 within a boundary 5. The boundary 5 may be a physical boundary, an edge of the mapped area, or any boundary 5 defined by a user. The map 3 includes external spaces 7 and buildings 9a, 9b, 9c defined by external boundary walls 11a, 11b, 11c. Interior spaces 13a, 13b, 13c are formed by the buildings 9a, 9b, 9c.

The map 1 includes the detailed floor plan of the interior spaces 13a, 13b of two of the buildings 9a, 9b. The floor plan defines internal walls 15, forming features such as rooms 17, corridors 19 and the like.

The map may not include floor plans for other internal spaces, such as the interior space 13c of the third building 9c may not include a floor plan. Therefore, this building 9c is shown in outline only.

It will be appreciated that although the map 3 includes the floor plan of a single storey of the buildings 9a, 9b, the map 1 may include floor plans of further stories, where they exist.

A number of non-traversable regions 23 (shown by diagonal hatching) are also defined on the map 1. People passing through the area 3 shown by the map 1 are not able to pass through these non-traversable regions 23a-c. The non-traversable regions may be interior non-traversable regions 23a or exterior non-traversable 23b,c. Examples of non-traversable regions 23 include service spaces, unpassable features (either naturally occurring or man-made) or fenced off areas.

Also defined on the map 1 are traversable regions 25. In some examples, any part of the map 1 is defined as either traversable or non-traversable. Thus any region not defined as traversable may be considered non-traversable or vice versa. Alternatively, regions may be defined as neither traversable nor non-traversable.

The map 1 may further include other features, such as:
floor change regions 21a where a user may transition between different floors of the building 9b (lifts, escalators or stairs);
doorways 21b into buildings 9a, 9b, 9c or rooms 17;
structures connecting buildings such as skyways (not shown);
other structures to facilitate entry/exit into the building, such as entry stairs and ramps (not shown);
parking spaces if the map includes a parking garage;
information on floor connectivity, where floor plans of multiple stories are included (which floor is connected with which and by which floor change structure);
roads;
external pedestrian zones and patio areas;
wireless communications signal maps illustrating where wireless communications signals emitted by identified beacons may be detected. This may include wireless signals such as WiFi, BTLE, RFID, BlueTooth, Digital Enhanced Cordless Telecommunications (DECT), ZigBee or cellular maps);
Signal maps of other detected ambient signals such as geomagnetic signals.

It will be appreciated that in some instances, the features may not be included in the graphical representation of the map, as shown in FIG. 1A. Instead, the features may be included as map data associated with the map. For example, non-traversable regions 23, signal maps and the like may not be shown on the map, but may be included as associated map data.

The map 1 shown in FIG. 1A is simply illustrative to show examples of different features that may exist on a map 1. The map 1 may include any possible combination of the features discussed above, and other features not shown, but which will be apparent to the person skilled in the art.

FIG. 1B shows a simplified map 1′ of a floor plan of a single storey of the second building 9b. The boundary 5′ of the map is defined by the boundary wall 11b of the building. In this example, the rooms 17 and floor change area 21a are defined as non-traversable regions, and so only the corridors 19 and communal spaces are traversable.

For the sake of clarity, the following description will discuss a method 400 of locating a plurality of mobile device trajectories captured in the area 3′ shown by the map 1′ of FIG. 1B relative to each other and the map 1′. However, it will be appreciated that the techniques could be applied to the map 1 shown in FIG. 1A or any other suitable map.

A user 100 can move around the area 3 shown by the map 1′. The user 100 may move around any of the traversable regions 25, and may carry a mobile device 101, such as a smart phone or a smart watch.

As will be discussed in more detail below, the skilled person will appreciate that the mobile device 101 may be any device capable of being moved around the area and may include sensors necessary for determining the trajectory along which it is moved. The mobile device 101 may therefore be or comprise any suitable smart phone, tablet, portable computer (e.g. lap-top), smart watch, Fitbit®, smart clothing, subdermal electronic device or implant, or the likes. In the embodiments being described, the mobile device 101 is sufficiently small and light-weight to be carried in a hand or pocket. In other embodiments, the mobile device 101 may be larger and/or heavier, and carried in a back-pack or on a trolley or the likes. Such a mobile device may be referred to as a portable mobile device. In still further embodiments, the mobile device may be a car or other vehicle, and the buildings 9a, 9b may be or comprise a multi-storey car park or the like. Automated robots or vehicles sensors necessary for determining the trajectory along which it is moved.

FIG. 2 illustrates a schematic view of some of the components of an example mobile device 101.

The mobile device 101 comprises at least one receiver 103a, 103b, which may comprise, in various embodiments, one or more GNSS receivers 103a and optionally one or more radio-communication signal receivers 103b.

In one example, the GNSS receiver(s) 103a may be a Global Positioning System (GPS) receiver. On other examiner, the GNSS receiver 103a may be for Global Navigation Satellite System (GLONASS), Galileo or BeiDou Navigation Satellite System (BDS) or any other type of positioning system.

In one example, the radio-communication signal receiver(s) 103b may be a WiFi receiver. The person skilled in the art will understand that WiFi is specified for convenience only and the skilled person will appreciate that any other suitable communication data may be used instead—the invention is therefore not to be limited to the use of WiFi. In alternative or additional embodiments Bluetooth® or other radio communication signals such as BTLE, RFID, BlueTooth, Digital Enhanced Cordless Telecommunications (DECT), ZigBee or cellular signals and the like may be used instead of or as well as WiFi.

The mobile device 101 may also comprise at least one sensor 105a, 105b such as an accelerometer, a gyroscope, a magnetometer, a barometer (i.e. a pressure sensor), an ambient light sensor, an acoustic sensor, a camera (monocular/stereo, RGB/thermal, etc.), a mmWave radar sensor, a temperature sensor, a wheel odometry sensor, and a compass, or similar.

Each of the receivers 103a, 103b and sensors 105a, 105b generates data. For example, the GNSS receiver generates GNSS data, the radio communications receiver generates signal data, the accelerometer generates acceleration data, the barometer generates pressure data, the temperature sensor generates temperature data.

The mobile device 101 further comprises a memory 107 subdivided into a program storage portion 109 and a data storage portion 111, a sending unit 113 and processing circuitry 115.

The receivers 103a, 130b, sensors 105a, 105b, memory 107, sending unit 113 and processing circuitry 115 may be in communication over a system bus 117. In some cases, the function of the processing circuitry 115 and/or memory 107 may be distributed over a number of connected units. These units may be connected over any suitable network connection, as well as through the bus 117.

The processing circuitry 115 may be or comprise one or more of the following processors: A7, A8, A9, A10 or A11 processors from Apple®, Snapdragon, an Intel® X86 processor such as an I5, I7 processor, an Intel Atom, or the likes.

The memory 107 may be provided by a cache memory, RAM, a local mass storage device such as the hard disk. The memory may also be provided remotely, and connected to the processing circuitry 115 over a network connection.

The mobile device 101 is arranged to process the data generated by the receivers 103a, 103b and sensors 105a, 105b. In the embodiment being described, in which the mobile device 101 is a smart phone, a software application 119 (often known as an App) is stored in the program storage portion 109 of the memory 107. The software application 119 comprises computer instructions, that when run on the processing circuitry 115 of the mobile device 101 cause the mobile device 101 to store, from time to time, the data generated from at least some of the receivers 103a, 130b and sensors 105a, 105b. The generated sensor data 221 is stored in the data storage portion 111 of the internal memory 21 of the mobile device 13.

In the embodiment being described, the processing circuitry 115 or software application 119 is arranged to time stamp the data generated by the receivers 103a, 130b and sensors 105a, 105b as the data is received and/or processed by the processing circuitry 19.

The sending unit 113 of the mobile device 13 is arranged to send the data to a data processing system 201 for further processing, as will be discussed below.

One or more network connections may be available to the sending unit 113. This provides for data transfer; for example via the Internet, but the skilled person would appreciate that any suitable data transfer means may be used. For example, Wi-Fi, the Global System for Mobile communications (GSM) and/or the Universal Mobile Telecommunications System (UMTS) may be used. Whilst it is convenient to use a Wide Area Network (WAN) such as the Internet any data connection such as an ad-hoc network, a dedicated connection between the mobile device 101 and the data processing system, etc. may be used.

FIG. 3A schematically illustrates an example of the data processing system 201. The data processing system includes a communications interface 203, arranged to receive data transferred from one or more mobile devices 101, as discussed in relation to FIG. 2.

The data processing system 201 includes a memory 205, subdivided into a program storage portion 207 and a data storage portion 209, and processing circuitry 211.

The processing circuitry 211, memory 205 and communications interface 203 are all in communication over a system bus 213. The processing circuitry 211 and memory 205 may further be in communication via the communications interface 203, where the functionality of the memory 205 and processing circuitry 211 is distributed.

The memory may be provided by a cache memory, RAM, a local mass storage device such as the hard disk. The memory may also be provided remotely, and connected to the processing circuitry 211 over a network connection.

The processing circuitry 211 may be or comprise one or more of the following processors: A7, A8, A9, A10 or A11 processors from Apple®, Snapdragon, an Intel® X86 processor such as an I5, I7 processor, an Intel Atom, or the likes.

The data storage portion 209 stores map data 219 encoding maps 1 of one or more areas 3. The map data 219 defines features as described above, such as traversable regions 25 and non-traversable regions 23, building outlines 11, floor plans and internal walls 15 of buildings 9, and other landmarks 15, 17, signal maps (e.g. geomagnetic signals, WiFi, BTLE, RFID, BlueTooth, Digital Enhanced Cordless Telecommunications (DECT), ZigBee or cellular signals). The data storage portion 209 is also arranged to store the data 221 received from the one or more mobile devices 101.

The data processing system 201 is arranged to process the data 221 sent by the mobile devices 101. The program storage portion 207 of the memory 205 contains a trajectory determination module 215, and a trajectory processing module 217 that contain software instructions that, when executed on the processing circuitry 211 of the processing unit 201, process the data 221 provided by the mobile devices 101.

The trajectory processing module 217 includes a number of sub-modules 225, 227, 229, 231 as will be discussed in more detail below. FIG. 3B illustrates the sub-modules 225, 227, 229, 231.

The trajectory determination module 215 processes the data 221 collected by the receivers 103a, 103b and sensors 107a, 107b of a particular mobile device 101 to generate a trajectory along which that mobile device 101 is moved.

FIG. 4 illustrates an example of a trajectory 301 determined for a mobile device 101. To obtain the trajectory 300, the data 221 received from the mobile device 101 is processed to provide a time series comprising the time stamped position of the corresponding device 101 at intervals, referred to as position nodes 303a-i. For example, the series may include nodes 303a-i every millisecond, or at any other suitable regularity. The trajectory 301 is formed by vectors 305a-h (also referred to as edges) extending between consecutive nodes 303a-i. Rather than including specific time stamps, the trajectory may simply comprise nodes arranged in time order, such that they are sequential.

The position nodes 303a-i may be generated using any available data, and may be defined in a frame relative to the mobile device 101, which may or may not be defined in a frame relative to GNSSs. Where accurate GNSS data is available, the position nodes 303a-i may be based on the GNSS data. The position nodes 303a-i may be based on a single GNSS reading, or multiple GNSS readings that are averaged. In other cases, where GNSS data is not available, or the accuracy of GNSS is unreliable, the positioned nodes 303a-i may be determined based on other data measured by the receivers 103a, 103b and sensors 107a, 107b.

In one example, a position node 303a-i may be determined based on a measured movement from the previous position node 303a-i. This is a process known as odometry. By way of example, this may be based on one or more of: determining a direction of movement based on accelerometer, gyroscope, compass or other sensors; determining a speed of movement based on sensor readings; determining a stride count, and using a previously calibrated stride length.

In general, an odometry algorithm, such as pedestrian dead reckoning, provides at each node 303a-i a data pair comprising a translation (i.e. the distance moved from the previous node 303a-i) and rotation (i.e. the relative orientation of the current step with respect to the previous step). In the example of pedestrian dead reckoning, the translation is referred to as a step length, and the rotation as a step turn. Where the node 303a-i represents the position and orientation of the device at a given time, it may also be referred to as a pose.

WO 2016/042296, the contents of which are hereby incorporated by reference, discloses an example of using pedestrian dead reckoning to determine a trajectory.

In at least some embodiments, further information may also be used to determine the location (relative or absolute) position of nodes 303a-i in the trajectory 301. For example, signal fingerprints, or other known measurable features/landmarks having fixed location may also be used to determine the position nodes. For example, a measured WiFi fingerprint may provide a distance and direction from a WiFi base station. Even when this data is not used in determining the position of the nodes 303, it may be included in the trajectory data, associated with a particular node.

In at least some embodiments, a trajectory 301 may be formed using position nodes 303a-i generated by one, or a combination of two or more of the above techniques. Furthermore, the above description is given by way of example only. Trajectories 301 may be determined by any suitable method.

In the embodiment being described, the trajectory 301 is calculated at the data processing system 201. However, it will be appreciated that the trajectory determination module 215 may be provided in the mobile device(s) 101 or elsewhere. Therefore, the data transmitted by the mobile devices 101 may include the calculated trajectory, or the trajectory may be received from a different platform entirely. The data storage portion 209 of the memory 205 of the data processing system 201 includes trajectory storage 223 for storing the trajectories 301 and associated data, whether calculated at the data processing system 201 or elsewhere.

A number of trajectories 301 may be collected in an area 3 covered by a map 1. The trajectories 301 may be obtained by use of one or more mobile devices 101, and mobile device 101 may provide one or more trajectory 301, each trajectory 301 corresponding to a trip through the area 3.

Where GNSS coverage is strong, a large portion of the nodes 303a-i of each trajectory 301 will include GNSS data. As such, the trajectories 301 can easily be positioned on the map 1, within the reference frame of the map 1.

Where GNSS coverage is of poor quality or unreliable, very few of the nodes 303a-i may include GNSS data. Some trajectories 301 may not have any nodes 303 with GNSS data. GNSS coverage may be poor in or near buildings, of for many other reasons. In this case, a large portion of the trajectories 301 will be determined by odometry methods such as pedestrian dead reckoning, and each trajectory 301 will be defined in its own frame of reference. Furthermore, due to inaccuracies in odometry methods, the trajectories 301 may contain various inaccuracies or errors. It is, however, desirable to still provide these trajectories overlaid on the map 1, defined in the same frame of reference as the map 1.

FIG. 5 shows a method 400 of aligning a group of trajectories 301 onto a map 1′. In order to explain the method 400, the example trajectories 301 are only taken inside the building 9b shown on the map 1′, and the rooms shown in the floor plan are considered to be non-traversable, such that the only traversable regions are corridors and communal spaces, as discussed above. The method 400 is further illustrated and described with respect to FIGS. 6 to 6G. The method 400 is carried out by the trajectory processing module 217 of the data processing system 201.

The method 400 includes a number of pre-processing steps 402a, 402b, 404. At a first-pre-processing step 402a, performed at the trajectory determination module 215, sensor data 221 is obtained and pre-processed to derive trajectory data 223, using appropriate odometry algorithms, as discussed above. The trajectory data 223 generated is then stored in the data storage portion 209 of the memory 205.

Any number of trajectories 301 may be determined. In some examples, there may be ten or fewer trajectories 301, a hundred trajectories 301, a thousand trajectories 301 or more. The trajectories 301 may be derived from sensor data 221 collected by one or more mobile device 101, each taking one or more trips through the area 3′ covered by the map 1.

To determine the trajectories 301, the sensor data 221 may be retrieved from data storage 209, or directly received from the processing circuitry 211 of the data processing system 201, or received from the one or more mobile devices 101.

The trajectories 301 need not be collected simultaneously, and may be collected over a period of time. It will also be appreciated that a number of trajectories 301 may be from a single journey of a mobile device 101, broken by periods in which insufficient data to generate a trajectory 301 is available. Furthermore, it will be appreciated that at least some of the trajectories 301 may not include any GNSS positioning data. Even where a trajectory 301 is provided with GNSS data, the GNSS data may not necessarily extend along the full length of the trajectory 301, and there may even be only a single GNSS data point along the length of a trajectory 301. Trajectories 301 may be a time series of variable duration, from seconds to hours.

Alternatively, as discussed above, the trajectory data 223, with trajectories 301 already determined, may be received from a separate source, or the mobile devices 101.

Optionally, a pre-processing filter may be applied to the trajectories 301, so that trajectories 301 that are estimated to have inaccurate relative motion information, such as an unrealistic sequence of position nodes, are rejected.

In other examples, trajectories 301 may be segmented based on height changes. For example, where an area 3 includes multiple stories, the trajectories may be segmented and grouped based on which storey they are likely to correspond to. WO 2020/089593 discloses a method of doing this. Each separate storey may then be considered a separate map.

Trajectories 301 may also be segmented to ensure each trajectory 301 has the same length or a maximum length.

In some examples, trajectories may begin, end or pass through areas inside or outside the map 1′. Trajectories 301 may be segmented to remove regions not covered by the map 1′. The person skilled in the art will appreciate that over the method 400, the position of nodes 303 may change such that nodes 303 may move from outside the area of the map 1′ to inside the area of the map 1′ and vice versa. Therefore, when segmenting to remove trajectories outside the map 1′, only those segments that are more than a threshold distance away from the map may be removed.

A further optional pre-processing filter step includes removing poor quality signals, e.g. WiFi signals with very few access points, or cellular signals with very few cellular towers. To reduce the processing cost of the method 400, signals may optionally be subsampled using either a time interval threshold between samples, or a travelled distance threshold between samples. Alternatively, samples of a given time or distance interval may be combined to obtain a single sample. If the majority of signals associated with a trajectory 301 are of poor quality and removed, then the entire trajectory 301 may be removed. Alternatively, a part (first and/or last segment) of a trajectory 300 with poor quality signals may be removed.

In a second pre-processing step the map data 219 is obtained and pre-processed into an internal representation of accessible areas (e.g. a 3D grid), landmarks (escalators, elevators, ramps, sky walks etc.), floor heights and connections, entrance/exit, disabled access pathways, building boundary, road and pedestrian zones and the like. As discussed above, the map data 219 may also include signal maps, showing the variation of different types of signals in different locations (for example, visual, point cloud, geomagnetic signals, WiFi, BTLE, RFID, BlueTooth, Digital Enhanced Cordless Telecommunications (DECT), ZigBee or cellular signals).

In a third pre-processing step 404, location, motion and loop closure constraints are generated by a front end module 225 of the non-linear optimiser, forming part of the trajectory processing module 217.

Location constraints provide fixed positions in a common reference frame of the trajectories 301, which may or may not be georeferenced.

Absolute location constraints may be determined by GNSS or pressure data, providing defined positions of nodes in the frame of reference of the map. Any trajectory 301 having a time stamp associated with a high accuracy GNSS measurement (or any other measurement in a global frame) may provide absolute location information about the pose of that trajectory at that time stamp. The uncertainty of the pose is based on the uncertainty of the GNSS measurement. The uncertainty is encoded in a co-variance matrix. In addition, the uncertainty may also be estimated by taking into account the frequency, proximity and reported accuracy of GNSS estimates in a small window surrounding that GNSS measurement.

Location constraints may also come from comparing a signal detected at a node with a signal map defined in the map data 219. The signal map could include information about the identities and locations of signal transmitters, and optionally knowledge of pertinent signal propagation models. Alternatively, the signal map could directly include signal signatures obtained via a manual survey or a crowdsourcing method (e.g. Wifi/BTLE/geomagnetic and other signatures).

Location constraints may also come from other recognisable landmarks detected by signals detected at the mobile device 101. For example, image analysis may identify the location of the mobile device relative to a physical landmark, and the GNSS location of the landmark may be known.

In further examples, the mobile device 101 may emit signals as a beacon. Detection of the mobile device by other devices may also provide location constraints.

Comparing the signal detected at a trajectory's pose against a signal map results in a new location constraint that could be represented in different ways. It could be an absolute location constraint on the trajectory's pose, or an edge constraint linking the trajectory's pose with a new pose representing a map point/landmark (such as the location of the beacon transmitting the signals). Such edge constraints could encode a full pose transformation with associated uncertainty, or partial relative pose information (e.g. distance between the trajectory's pose and a new pose corresponding to a transmitter on the map). In some examples, the detected signal may also allow the relative orientation of the mobile device from a transmitter (e.g. the signal may vary in different quadrants surrounding the transmitter). Where the signal allows the orientation of the mobile device 101 relative to the transmitter to be determined, this may also be included as a relative location constraint.

Poses introduced to the pose graph to represent points/landmarks on the map can be associated with absolute location information if the map is georeferenced, or they could be linked to each other with relative pose constraints, to reflect their relative positions on the map (if the map is not georeferenced).

Motion constraints are generated from the trajectory data 223 using a motion tracking (odometry) algorithm. Odometry algorithms used may be based on signal processing and/or machine learning algorithms, and they may use inertial, visual, mmWaveRadar, thermal, wheel odometry and other similar sensor data that can be used to measure relative pose between two consecutive poses and associated uncertainty.

Motion constraints define how different nodes 303 or sub-sequences of nodes 303 within a trajectory 301 are arranged relative to each other. Each node 303 or sub-sequence of nodes 303 has an uncertainty (or confidence) associated with it. The uncertainty determines the likelihood that the associated part of the trajectory will be changed. For example, if a series of nodes has high confidence, that series is likely to be maintained in its shape during optimisation, while a series with low confidence may be altered during optimisation.

Motion constraints can be obtained from a pedestrian dead reckoning technique, or they can be generalised to device motion not based on steps, e.g. trolleys, robots and vehicles, as well as device motion in 3D (e.g. small unmanned aerial vehicles).

Loop closure constraints are generated based on similarity of device sensor data (using different similarity metrics and one or more types of sensor data). Loop closures are defined when, for example, one signal (or a sequence of signals) associated with one trajectory 301 has high similarity to another signal (or a sequence of signals) associated with another trajectory 301 (or another part of the same trajectory at a different time). In other words, a loop closure is formed when two trajectories 301 measure similar signals, and so the trajectories 301 are determined to be at the same or similar locations. The signals need not necessarily have been used to determine the trajectory 301 they may have simply been measured concurrently with the data that was used to measure the position node with a corresponding time stamp.

Any of the data collected at the receivers 103a, 103b and sensors 105a, 105b can be used to determine relative loop closures. For example, loop closures may be achieved using a fingerprint of a received radio communication signal (for example, WiFi, BTLE, RFID, BlueTooth, Digital Enhanced Cordless Telecommunications (DECT), ZigBee or cellular signals; visual data; light data; pressure data; geomagnetic data; pedestrian dead reckoning data, and the like. Either single measurements or sequences of measurements of the sensor or radio data can be used for loop closures.

Loop closures 309a may be derived from a single signal modality (e.g. WiFi only) or a plurality of signal modalities (e.g. a combination of WiFi, BTLE, RFID, BlueTooth, Digital Enhanced Cordless Telecommunications (DECT), ZigBee or cellular signals, magnetic, light, etc.). In an alternative embodiment, loop closures 309a could be formed by additionally taking into account the shape of the trajectories, i.e. relative motion information used to generate motion constraints.

The confidence of loop closures 309a is derived based on statistics of the pairwise similarity between signals, e.g. their number, similarity values and variance, and optionally based on the shape similarity. The confidence of a loop closure is a measure of how likely the loop closure is to be correct. For example, where loop closure is determined based on the similarity of measured signals, the confidence is determined based on how similar the two signals are. Where a combination of signals are used to determine loop closures, the similarities of the different signals would be combined. The confidence is used to bring different parts of trajectories 301 closer together, when position the trajectories 301 relative to each other (e.g. where there is high confidence in a loop closure, the trajectories are brought closer together than where there is low confidence).

If the estimated confidence is too low, loop closures do not draw the corresponding trajectories 301 close enough during optimisation so the overall solution fails to correctly align trajectories. On the other hand, if the estimated confidence is too high, the trajectories 301 are distorted during optimisation to satisfy the spurious loop closures.

FIG. 6A illustrates an example of a plurality of trajectories 301a, 301b, 301c obtained in the first pre-processing step 402a with odometry and loop closure constraints generated in the second pre-processing step 404 also illustrated. As discussed above, the trajectories shown in FIG. 6A are all collected inside the building 9b shown in the map 1′ of FIG. 1B. The trajectories 301a, 301b, 301c, are obtained in the area shown by the map 1′ of FIG. 1B.

Dotted lines indicate loop closure constraints 309a where edges 305 or nodes 303 should be at substantially the same place. Continuous lines indicate motion constraints 3096b. The dots represent nodes 303′ where a change in direction is determined in the trajectory 301a, 301b, 301c, by motion constraints 309b, or nodes at the start/stop of the trajectory 301a. 301b, 301c. There may be a plurality of nodes 303 provided along the trajectory 301a, 301b, 301c between the direction change nodes 303′, these nodes are omitted for clarity. In this example, location constraints are omitted.

The trajectories in FIG. 6A form an input pose graph 311 that is generated by the front end module 225 (for example a SLAM front end). The input pose graph 311 represents the collection of trajectories 301a, 301b, 301c in a single frame of reference, relative to each other, and encodes the constraints discussed above, namely location, motion and loop closure constraints.

The frame of reference may be georeferenced if GNSS information is available in the sensor data, or may be defined relative to a different map reference frame if sensor data are located against a signal map, or both. Alternatively, the input pose graph may not be defined in an external reference frame.

In a first processing step 406 of the method 400, the input pose graph 311 is optimised by a back end module 227 (non-linear optimiser). The input pose graph 311 is optimised by reference to a cost function based on the determined constraints 309. Within the pose graph 311, each constraint has an associated error that specifies the deviation of the pose graph 311 from the ideal solution specified by the specific constraint. The error may be a linear distance, squared distance or similar. The optimisation process attempts to minimise the total error (the cost function) by modifying the trajectories 301a, 301b 301c.

Furthermore, in at least some non-linear optimisation techniques, each loop closure 309 has an associated confidence/uncertainty level. The cost function may include weighting, so that greater variation can be accommodated in constraints with higher uncertainty. In other words, for two constraints with the same error and different uncertainty, the contribution to the cost function will be less for the constraint with the lower confidence.

Optimisation processes to estimate poses that minimise the cost function of the errors introduced by the constraints are typically iterative, and they either target to optimise all poses together, or update local parts of the pose graph. Various non-linear optimisation methods are known in the art for solving this problem. In one example, the non-linear optimisation process may be a Simultaneous Localization and Mapping (SLAM) process. Various SLAM processes are known. WO 2019/025788, the contents of which are hereby incorporated by reference, provides details on one method of providing loop closures between trajectories using a SLAM technique. Techniques, such as disclosed in WO 2019/025788, can also be used to remove false loop closures and insert additional ones that are correct with high confidence.

In one embodiment, the non-linear optimisation process is run until a defined convergence threshold is achieved, such as stabilisation of the cost function. However, in another embodiment, the non-linear optimisation process is simply run for a defined time or number of iterations. As will be discussed in more detail below, further processing of pose graph 311 is carried out after the nonlinear optimisation, and so it is not necessary to obtain convergence at this stage. Not requiring convergence at this step can speed up the method 400 and reduce use of processing resources.

The output of the non-linear optimisation process is a modified pose graph 313 as shown in FIG. 6B. As can be seen from FIG. 6B, the relative shapes of the trajectories 301a, 301b, 301c are changed, and the location of the trajectories 301a, 301b, 301c relative to each other is also changed. In FIG. 6B, there are a number of regions 307 in which the position of two of the trajectories 301a, 301b, 301c have been found to coincide.

The modified pose graph 313 provides a first estimate of the shape and relative locations of the trajectories 301a, 301b, 301c.

In a second processing step 408, the modified pose graph 313 is overlaid onto the map 1′, to provide the modified pose graph 313 in a common reference frame with the map 1′. This is carried out by a pose graph transformation module 229 of the trajectory processing module 217.

In one embodiment, where the pose graph 313 includes at least some location information in the same frame of reference as the map (e.g. GNSS information) the pose graph transformation module 229 thus applies a transformation to the modified pose graph 313 to align the points with known locations to the map 1′.

In a second embodiment, where the frame of reference of the pose graph 313 is not relatable to the frame of reference of the map 1′, other techniques such as pattern matching may be used to identify common points on the modified pose graph 313 and the map 1′. These techniques look at the complete modified pose graph 313. For example, the long corridor 19 towards the centre of the map 1′ may be identified as corresponding to the long straight section of the first trajectory 301a. Again, when common points are identified, the pose graph transformation module 229 thus applies a transformation to the modified pose graph 313 to align the points. Various map matching/point registration techniques are discussed below.

Further information may also be used to determine the transformation required to make a first estimate of aligning the modified pose graph 313 with the map 1′. For example, in the embodiment under discussion, all trajectories 301 are obtained inside a building 9′ defined on the map 1′. The internal plan of the building is known on the map 1′. Thus, all the optimised trajectories 311 should fall within the outline of the building 9′.

Further location constraints may be generated based on the alignment of the pose graph 313 with the map 1′.

In the above example, a rigid transformation is applied to the modified pose graph 313 to generate an aligned modified pose graph 315. The rigid transformation applies only rotation and translation, and preserving the overall shape of the pose graph.

FIG. 6C illustrates the aligned modified pose graph 315 overlaid on the map 1′ of FIG. 1B.

As can be seen from FIG. 6C, the trajectories 301a, 310b, 301c cross walls or other obstacles. This suggests the initial placement of the modified pose graph 313 is incorrect, and/or the shapes of the trajectories 301a, 310b, 301c are incorrect. Errors may occur for a number of reasons, including inaccuracies of location constraints (GNSS or map-based), loop closures, inaccuracies in odometry used to determine the original trajectories 301 and the like.

In examples where insufficient information exists to apply a transformation and make a first estimate of aligning the modified pose graph 313 with the map 1′ the modified pose graph 313 may be arbitrarily aligned with the map 1′.

In a next step 410 of the method 400, one or more sub-graphs are extracted from the aligned optimised pose graph 315 by a sub-graph extraction sub-module 231 of the trajectory processing module 217.

In one example, the sub-graphs may contain all the nodes 303 and edges 305 corresponding to a single trajectory 301a, 301b, 301c or part (segment) of a single trajectory.

In another example the sub-graphs may contain all the nodes and edges corresponding to a selected subset of two or more trajectories (or segments thereof) together with loop closure constraints connecting pairs of them in the selected subset.

In yet another example the sub-graphs may contain all the nodes 303 where a particular type of landmark is detected (for example, a lift structure) from device sensor data. Landmarks may be identified in trajectory data in a number of ways.

For example, data measured by the receivers 103a, 103b or sensors 105a, 105b can detect height changes through pressure changes, accelerometers and the like. WO 2020/089593, the contents of which are hereby incorporated by reference, discloses methods for identifying height changes in trajectories 301.

Landmarks may also be identified in the trajectory 311a using detected ambient signals, shape/pattern matching of the map 1′ and portions of the trajectory 311a, image analysis and the like.

When identifying sub-graphs based on landmarks, it will be appreciated that a sub-graph may be the nodes 303 where a particular type of landmark or combination of landmarks is detected. Furthermore, it may also include nodes 303 and edges 305 within a certain range of the landmark and/or nodes and edges in paths that connect those landmark.

It will be appreciated that where a plurality of sub-graphs are extracted, all sub-graphs extracted may be based on the same one of the criteria discussed above, or different sub-graphs may be extracted based on different criteria. Furthermore, sub-graphs may be overlapping or non-overlapping.

The next step of the method 400 is a first sub-graph processing step 412, where each sub-graph is processed individually, by a map matching sub-module 233 of the trajectory processing module 217. Each sub-graph is processed to match it to the features of the map 1′, using the map data 219.

The map matching sub-module could use a variety of different techniques including a Hidden Markov Model, a Particle Filter or other probabilistic state estimation algorithms based on directed graphical models. Alternatively, probabilistic state estimation algorithms based on undirected graphical models (such as conditional random fields) may be applied. Alternatively, map data can be internally modelled as a graph, and graph matching transform functions (rigid, non-rigid or as rigid as possible (ARAP)) could be applied to distort the optimised trajectories 311 into map matched trajectories. In further examples, point registration (e.g. ICP) type algorithms, and other graph matching algorithms may be used.

The map matching method used will modify the positions of nodes 303 and edges 305 in the trajectory 301 in a number of ways.

In one example, nodes 303 in non-traversable regions will be associated with positions in traversable regions (for example the nearest traversable region) and moved to the associated position on the map 1′.

In a second example, the sub-graph may be processed based on boundaries defined on the map 1′. This may involve, for example, determining whether nodes should lie within a particular boundary or outside it. Nodes may then be associated with positions inside or outside the boundary, and moved to the associated position.

For example, in the case discussed above, where all trajectories 301 should fall within the boundary of the building 9b but not in the rooms, any nodes 303 within the sub-graph that fall outside the building or within the rooms are identified as being incorrectly placed. In some cases, where a group of nodes 303 fall outside the boundary, the group may be extracted as a sub-graph in step 410.

In other examples, further signal information may be required. For example, in cases where the map 1 includes both indoor and outdoor regions, strength of GNSS signals or other ambient signals can be used to determine if nodes 303 are correctly placed inside or outside of boundaries. For example, if the GNSS signal is relatively weak, this may correspond to a node that should be within a building, or near it. Alternatively, for example, a strong signal from a wireless beacon known to be inside a building may suggest the node 303 should be inside.

In cases where the map 1 defines transitions into and out of areas defined by boundaries, such as doors 21b, a further determination may also be made to determine that edges 305 only cross boundaries at these transitions. Therefore, for example, where a trajectory passes from outside a building to inside a building (as determined by ambient signal strength, for example), the nodes 303 and edges 305 may be associated with the transition and moved to the associated position on the map 1′.

It will be appreciated that in some cases, internal walls 15 may also define boundaries. For example, where the map 1 defines transitions where boundaries in internal walls may be crossed, these transitions may be processed in the same way as transitions in external walls. Where the internal walls (floor plan) of the building are not known, the whole building is treated as a single interior region, such that the nodes 303 determined to be inside the building can be located anywhere in the interior space defined.

In a third example, the sub-graph may be map matched based on landmarks defined on the map 1′. Landmarks may include a number of features such as:
Regions in which height changes occur (such as lifts, stair wells and the like);
Signal fingerprints (comprising an identifier and optionally signal strength) of ambient signals, such as wireless or Bluetooth beacons;
Regions of defined shape (for example a corridor may comprise a long straight region).
   It will be appreciated that these landmarks are given by way of example only. Other suitable landmarks may be defined.

The nodes are processed to identify landmarks as discussed above. Optionally, the landmark may be classified, for example, as height change, signal fingerprint and the like. If necessary, the shape of the landmark may also be determined. Nodes 303 may then be associated with the closest landmark and moved to the associated position on the map 1′. Where landmarks are classified, nodes 303 may only be associated with the closest landmark of the same classification. Where the shape of a landmark in the trajectory is determined, the shape may be matched to regions on the map 1′.

Alternatively as discussed above, the sub-graph may not correspond to the poses of a single trajectory (or a selection of trajectories), but instead corresponds to all poses identified as associated with a landmark or group of landmarks (of the same or different types). Such poses are referred to as poses of interest (POIs). Connecting poses (CPs), poses in the shortest path between pairs of POIs, can also be included in the same sub-graph. Respective locations (or landmarks) of interest (LOIs) and connecting routes can be identified in the actual map. Map matching techniques can be used to associate POIs in the sub-graph with LOIs in the map and move the nodes or edges to the associated position.

It will be appreciated that these landmarks (e.g. floor change structures) are given by way of example only. Other suitable landmarks may be defined that have the property that they are identifiable both in the provided map, and in the pose graph (optimised trajectory poses from Step 3). For example these could be characteristic shapes of corridors and shapes of trajectories.

Landmarks may be defined as points or areas on the map 1′. Where landmarks are defined as areas (for example a region in which the height may change or a region in which a particular signal fingerprint can be detected) they may be treated in the same way as boundaries. In other words, where a corresponding landmark is identified at a node 303 in the trajectory, the node 303 may be moved to within the region defined as a landmark on the map 1.

It will be appreciated that a trajectory 301 may be aligned to the map 1′ using any one of the physical map features or constraints discussed above, or any combination of these features constraints. The constraints may be considered sequentially, in any order, or at the same time.

The person skilled in the art will be aware of various map matching techniques (also referred to as point registration) for aligning a sub-graph to a map 1′. A summary of some examples of techniques are set out in “A Review of Point Set Registration: From Pairwise Registration to Groupwise Registration”, Hao Zhu, Bin Guo, Ke Zou, Yongfu Li, Ka-Veng Yuen, Lyudmila Mihaylova and Henry Leung, Sensors, 2019, 191 1191, the contents of which are hereby incorporated by reference.

The map aligning step 412 applies the physical constraints defined by the map (such as traversable/non-traversable regions, boundary walls, floor change structures, and the like) to individual trajectories 301a, 301b, 301c or other sub-graphs from the aligned modified pose graph 315.

After a sub-graph is map matched in 412 the resulting subgraph has nodes with new updated poses. We refer to the resulting subgraph as map matched subgraph 319, and the new poses as map matched poses. FIG. 6D illustrates a map matched pose graph 319, in which the three trajectories 301a, 301b, 301c have been map matched. In this example, each individual trajectory was considered a separate sub-graph.

In a second sub-graph processing step 414, each map matched sub-graph is processed by a constraints determining module 235 to generate new constraints for the non-linear optimiser module 227. The constraints determined at the non-linear optimiser front end module 225 comprise first constraints, whilst the new constraints from the map matched sub-graph comprise second constraints.

In one example, each new estimated pose in the map matched sub-graph 319 can be used to derive a new location constraint. In the various examples discussed above, nodes 303 and edges 305 in sub-graphs may be associated with positions in the map 1′ during the map matching step 412. The result of the association step can be used to provide new location constraints.

If the modified pose graph 313 and the map matched sub-graph have different reference frames (for example if the step 408 of aligning the modified pose graph to the map 1′ is not possible due to lack of data), then new motion constraints may be generated that reflect the shape of the map matched trajectories.

Alternatively, a rigid or non-rigid transformation may be first be applied to bring the map matched sub-graph in the same reference frame as the original modified pose graph 313, before generating new location constraints on the map matched sub-graph.

The sub-graph processing steps 412, 414 are performed for each of the extracted sub-graphs. After each of the sub-graphs has been processed, the new location constraints are checked against the modified pose graph 313 derived by the backend module 227 in a check step 416. To do this, a new cost function is determined based on the new constraints and compared to one or more termination thresholds for the method 400. FIG. 6E schematically illustrates the new constraints 317 applied to the modified pose graph 313 as dotted lines. The length of the dotted line (i.e. the spacing of the pose graph of where it should be according to the new constraints from where it is) is representative of the error.

If the errors (or an aggregate statistical measure of them—the cost function) incurred by these new constraints are small (below one or more threshold values), the process ends, and the optimised pose graph is returned at step 418.

If however, these errors (or cost function) are large (above a threshold), then the method proceeds to step 420, where the new constraints determined in step 414 are fused with the original constraints obtained in the pre-processing step 404. This process will be discussed in more detail below.

The fusion of the two sets of constraints weighs old constraints (determined in step 404) and new constraints (determined in step 414) appropriately based on the level of confidence in the accuracy of the map 1′ and the old constraints.

In the fusing step 420, if new and old constraints contradict each other significantly the relative weights assigned to the new or old constraints could be such that the new constraints are prioritised (more heavily weighted) over the old ones, which may be completely removed. Alternatively, if, for example, the map 1′ is expected to have severe errors, the old constraints may be prioritised over the new ones. Alternatively, a suitable balance between the two sets of constraints may be identified.

In some examples, the different sets of constraints may be prioritised differently in different regions of the pose graph 313. For example, where the confidence in the map varies across the area (for example if some floor plans are not well known).

Removing (or reducing the confidence/weighting of) the original location, odometry or loop closure constraints in a part of the pose graph 313 is similar to removing the trajectories or parts of the trajectories linked to these constraints. Removing (or down-weighing) the new constraints after map matching is similar to ignoring or not attributing enough importance to the respective map features that led to these new constraints.

Once the constraints are fused, they are passed back to step 406. The process then repeats using the new fused constraints in the non-linear optimisation back end module 227. The process is repeated iteratively until the new constraints sufficiently agree with the optimised trajectories at which point optimised trajectories are returned in step 418.

In each iteration after the first, the modified pose graph 313 from the previous iteration is taken as the input pose graph 311, and the fused constraints from step 420 in the previous iteration are used as the initial constraints in the optimisation step 406.

FIG. 6F illustrates the modified pose graph 313 determined by the non-linear optimisation in the second iteration overlaid onto the map, showing the constraints 317 determined in the first iteration. FIG. 6G illustrates the result of map matching the modified pose graph 313 shown in FIG. 6F. Comparison of FIG. 6C to FIG. 6F shows that, even without the second map matching stage, the modified pose graph 313 is much closer to the map 1′.

Each iteration updates pose graph 313 and constraints used, and the check in 416 determines how close the modified pose graph 313 is to the map 1′. The sub-graphs used may vary from iteration to iteration or be kept the same.

When comparing the cost function to the threshold(s), either the absolute value of the cost function or the rate of change of the cost function can be considered. The method may be determined to end as soon as the error (absolute value or rate of change) falls below the threshold. Alternatively, the cost function (absolute value or rate of change) may be required to be below the threshold for a predetermined number of iterations.

Optionally, a trajectory in the pose graph 313 may be cut, and segments of it may be removed between iterations, if new and old constraints consistently contradict each other in a particular section of a trajectory. This may, for example, remove parts of trajectories 310 preventing the method 400 reaching convergence.

In at least some embodiments, the weight of different types of constraints may change with the number of iterations. For example, loop closure constraints may have different uncertainty estimates in the first and second iterations of the process.

A high uncertainty (low confidence) for loop closure constraints is applied in the first iteration. The uncertainty is then reduced for those loop closures that are not contradicting the new constraints added in their spatial vicinity following the map matching in step 412, but may be increased for those loop closures that are inconsistent with the new constraints. In other words, the loop closures that are well satisfied after map matching are positively reinforced, and those that are not well satisfied are negatively reinforced (or rejected). A similar approach could be applied to other types of constraints (e.g. location and motion constraints).

By the fusion of new and old constraints, the non-linear optimisation process gradually approaches a solution that agrees with the map 1′. Furthermore, different levels of confidence to device and map-sourced information may also be applied, and different relative weights in different parts of the pose graph may be applied based on prior information about the accuracy of certain devices and the accuracy of different parts of the map.

The steps discussed above determine when the method 400 ends successfully. Optionally, the method may also be aborted in other circumstances.

For example, if convergence (where the value of or rate of change of the cost function is below the threshold) has not being reached after a certain number of allowable iterations, then the process moves to step 422, where the process is terminated. Depending on the implementation of this step, it could either mean aborting the process or restarting it with a new dataset of device data, and/or an improved map. This situation may be reached, for example, when the map data 1′ significantly contradict the device sensor data, suggesting that one source of these two sources of information or both have major inaccuracies.

In other examples, the method may proceed to step 422 if, for example, the cost function (absolute value or rate of change of value) increases or stays above a threshold without improvement.

In the example discussed above, the cost function for the entire pose graph is calculated at step 416. If the cost function is above the threshold, the process is iterative repeated on the whole pose graph 313 and if the cost function is below the threshold, the entire pose graph is output.

This is by way of example only. In other examples, the pose graph may be segmented into a plurality of areas, some of the areas having relatively low value for the cost function based on the second constraints, and some areas having relatively high value for the cost function based on the second constraints. In this case, the mean and/or variance of the cost function may be considered to segment the regions. The regions determined as relatively low cost function or relatively high cost function may be determined relative to a predetermined threshold, or relative to the cost function for the total pose graph. Alternatively, the sum of the cost function for the nodes an edges in a region may be determined.

Sub-graphs of the nodes and edges in those regions which have relatively low cost function are returned as optimised trajectories, and the input pose graph for the next iteration uses only the regions where the value of the cost function is relatively high. Each sub-graph representing a region with relatively high cost function may be processed separately, or the sub-graphs may be combined into a single pose graph.

At the end of the process, the different outputted sub-graphs, covering all or some of the original trajectories, may be combined into a single pose graph.

Alternatively, the full pose graph may be maintained for the iteration, but the sub-graphs selected for map matching may only be taken from the areas where the cost function value is above the threshold.

The pose graph 313 may be segmented based on the graph itself (for example into a regular grid or based on features in the map). Alternatively, the pose graph may be segmented based on the errors determined for each individual constraint determined from the map matching of the sub-graphs. In this way, clusters or regions with cost function below the threshold can be identified.

It will be appreciated that the segmented regions may be overlapping or not.

The example discussed above makes use of a map 1′ of a single building 9b which has the rooms defined as non-traversable, and a pose graph 313 having only three trajectories. The person skilled in the art will readily appreciate that the techniques discussed above are generally scalable to larger and more complex pose graphs with more trajectories 301 in the pose graph 313 and to more complex maps 1.

In the example discussed above, all three trajectories 301 are used as sub-graphs. However, in some cases, the sub-graphs will only form a sub-set of the data taken from the mobile devices 101.

In the example discussed above, the input pose graph 311 for an iteration is taken as the modified pose graph determined in the previous iteration. This may be by way of example only. Instead, the same input pose graph 311 determined at step 404 may be used at every iteration, with only the constraints modified by the fusing step 420.

In the above example, the physical map and the space traversed by the plurality of available trajectories fully overlap. However, this may not be the case, and the trajectories may be segmented during the method 400, when nodes and edges outside the area of the map 1 are identified.

The map may or may not be geo-referenced. If it is not geo-referenced, there is prior knowledge that suggests that the map area has a significant overlap with the space that the input device trajectories cover. If the map is not geo-referenced, and signal maps are used to generate location constraints at the non-linear optimiser frontend, these location constraints are defined in the reference frame of the map.

In the example discussed above, the input pose graph 311 is generated by processing device sensor data. It will, however, be appreciated that the input pose graph may be obtained in any way. For example, the method may be performed on a previously obtained input pose graph. Similarly, in the example discussed above, the map 1′ is processed in a pre-processing step 402a. However, in other examples, the map data may be provided without need for pre-processing.

It will be appreciated that the method 400 discussed above may be wholly performed at the data processing system 201. Alternatively, parts of the method 400 may be performed at the mobile device(s) 101 which collect the trajectories 301. It will also be appreciated that the data processing system 201 may be formed by one of the mobile devices 101.

1. A computer implemented method of locating a plurality of mobile device trajectories relative to each other and a map, the mobile device trajectories comprising a time series of position nodes joined by edges, the method comprising:
a. obtaining an input pose graph comprising a plurality of mobile device trajectories and a plurality of first constraints defining the position and orientation of nodes and edges of the trajectories relative to each other;
b. performing a non-linear optimisation process on the input pose graph based on the first constraints, to reduce a cost function associated with the first constraints, the non-linear optimisation process providing a modified pose graph;
c. extracting one or more sub-graphs from the modified pose graph, and for each sub-graph, individually processing the sub-graph to map match the nodes and edges of the sub-graph to features defined in the map;
d. generating second constraints based on the one or more map matched sub-graphs;
e. combining the first constraints and second constraints to form new fused constraints; and
f. repeating the non-linear optimisation process using the new fused constraints, to reduce the cost function, the processing providing a second modified pose graph.

2. The method as claimed in claim 1, wherein repeating the non-linear optimisation process comprises applying the new fused constraints to the modified pose graph obtained from the previous performance of the non-linear optimisation process.

3. The method as claimed in claim 1, wherein each of the first constraints and second constraints has an associated uncertainty, the uncertainty determining the contribution of the constraint to the cost function, and wherein combining the first constraints and second constraints to form new fused constraints comprises:
combining the first constraints and second constraints; and
modifying the uncertainty of the first constraints and second constraints.

4. The method of claim 1, wherein at least one of the one or more sub-graphs comprises one or more of the following:
all the nodes and edges corresponding to a single trajectory or a segment of a single trajectory;
all the nodes and edges corresponding to a selected subset of two or more trajectories or segments thereof, and loop closure constraints connecting pairs of nodes or edges in the selected subset; and
nodes from two or more trajectories having a corresponding common feature detected in device sensor data concurrent with the node.

5. The method of claim 4, wherein at least one of the one or more sub-graphs comprises nodes from two or more trajectories having a corresponding common feature, and wherein the at least one of the one or more sub-graphs further comprises nodes and edges within a threshold distance of the nodes having a corresponding common feature.

6. The method of claim 1, comprising, between processing the input pose graph based on the first constraints in a non-linear optimisation process and extracting one or more sub-graphs from the modified pose graph:
applying a rigid transform to the pose graph to align the pose graph with features of the map, wherein the one or more sub-graphs are extracted from the rigidly transformed pose graph.

7. The method of claim 6, comprising generating location constraints based on the rigid transformation, and incorporating the location constraints into the first constraints.

8. (canceled)

9. (canceled)

10. The method of claim 2, wherein
the first constraints comprise at least one of:
absolute location constraints;
loop closure/relocalisation constraints, identifying relative pose information between two nodes or between two short sequences of nodes in different trajectories, or in the same trajectory but at a different time period, unspecified in the frame of the map; and
motion constraints between consecutive nodes in the same trajectory; and
the second constraints comprise at least one of:
absolute location constraints;
loop closure/relocalisation constraints, identifying relative pose information between two nodes or between two short sequences of nodes in different trajectories, or in the same trajectory but at a different time period, unspecified in the frame of the map; and
motion constraints between consecutive nodes in the same trajectory.

11. (canceled)

12. The method of claim 1 wherein the non-linear optimisation process is iterative, and is stopped after a pre-determined number of iterations, without a convergence check.

13. The method of claim 1, wherein obtaining an input pose graph comprises at least one of:
obtaining and pre-processing device sensor data and map data pertaining to the same area to form trajectories; and
pre-processing map data to form an internal representation the map.

14. The method of claim 13, wherein obtaining an input pose graph further comprises:
generating an initial pose graph based on the trajectories.

15. The method of claim 1, wherein individually processing the sub-graph to map match the nodes and edges of the sub-graph to features defined in the map comprises one or more of:
a probabilistic state estimation algorithm based on directed graphical models;
a probabilistic state estimation algorithm based on undirected graphical models;
an as rigid as possible transformation;
a point registration algorithm;
other graph matching algorithms.

16. (canceled)

17. A data processing system for locating a plurality of mobile device trajectories relative to each other and a map, the mobile device trajectories comprising a time series of position nodes joined by edges, the data processing system comprising:
processing circuitry arranged to:
obtain an input pose graph comprising a plurality of mobile device trajectories and a plurality of first constraints defining the position and orientation of nodes and edges of the trajectories relative to each other;
perform a non-linear optimisation process on the input pose graph based on the first constraints, to reduce a cost function associated with the first constraints, the non-linear optimisation process providing a modified pose graph;
extract one or more sub-graphs from the modified pose graph, and for each sub-graph, individually processing the sub-graph to map match the nodes and edges of the sub-graph to features defined in the map;
generate second constraints based on the one or more map matched sub-graphs;
combine the first constraints and second constraints to form new fused constraints; and
repeat the non-linear optimisation process using the new fused constraints, to reduce the cost function, the processing providing a second modified pose graph.

18. A computer implemented method of locating a plurality of mobile device trajectories relative to each other and a map, the mobile device trajectories comprising a time series of position nodes joined by edges, the method comprising:
a. obtaining an input pose graph comprising a plurality of mobile device trajectories and a plurality of first constraints defining the position and orientation of nodes and edges of the trajectories relative to each other;
b. performing a non-linear optimisation process on the input pose graph based on the first constraints, to reduce a cost function associated with the first constraints, the non-linear optimisation process providing a modified pose graph;
c. extracting one or more sub-graphs from the modified pose graph, and for each sub-graph, individually processing the sub-graph to map match the nodes and edges of the sub-graph to features defined in the map;
d. generating second constraints based on the one or more map matched sub-graphs;
e. calculating a cost function based on the second constraints;
if the cost function based on the second constraints is above a threshold iteratively repeating the process; and
if the cost function based on the second constraints is below the threshold, terminating the method and outputting the one of the input pose graph and the modified pose graph.

19. The method of claim 18, wherein iteratively repeating the process if the cost function based on the second constraints is above a threshold comprises:
combining the first constraints and second constraints to form new fused constraints; and
repeating steps b to e, wherein the new fused constraints are used as the first constraints in step b.

20. (canceled)

21. (canceled)

22. The method of claim 18, wherein calculating a cost function based on the second constraints comprises:
segmenting the modified pose graph into a plurality of regions, each having a separate cost function, the plurality of regions including low cost regions in which the cost function for the second constraints has relatively low mean or variance and high cost regions in which the cost function for the second constraints has relatively higher mean or variance.

23. The method of claim 22, further comprising:
selecting sub-graphs representing the high cost regions;
iteratively repeating the process of fusing first and second constraints for the selected sub-graphs,
wherein the selected sub-graphs are optionally combined into a single pose graph prior to fusing the constraints.

24. The method of claim 22, wherein in a particular iteration, the non-linear optimisation process is performed on the full pose graph, and wherein extracting one or more sub-graphs from the modified pose graph comprises extracting the one or more sub-graphs from the high cost regions, in the previous iteration.

25. The method of claim 22, wherein the plurality of regions are overlapping.

26. The method of claim 18, comprising:
terminating the method when at least one of the following criteria are met:
a maximum number of iterations is performed; and
the cost function based on the second constraints increases over a number of iterations, or is unstable over a number of iterations.

27-41. (canceled)
